(19) United States
(12) Patent Application Publication
(10) Pub. No.: US 2017/0283164 A1
(43) Pub. Date: Oct. 5, 2017

(54) TEA BAG WITH STEVIA SYSTEMS

(71) Applicant: CARLOS ROEL ARANOZ, Toronto (CA)

(72) Inventor: CARLOS ROEL ARANOZ, Toronto (CA)

(21) Appl. No.: 15/474,072

(22) Filed: Mar. 30, 2017

Related U.S. Application Data
(60) Provisional application No. 62/317,405, filed on Apr. 1, 2016.

(51) Int. Cl. B65D 85/812; A23F 3/16

(52) U.S. Cl. CPC B65D 85/812; A23F 3/16

(57) ABSTRACT

A tea bag with stevia system provides a device to deliver tea leaves and stevia leaves in a single-use tea bag. The tea bag with stevia system is defined by a single-use, filter-paper envelope, tea leaves, stevia leaves, a string, and a tag. The filter-paper envelope is structured and arranged to contain a proportional composition of tea leaves and stevia leaves in a ‘ready-to-brew’ condition with the string attached to the exterior of the filter-paper material envelope and the tag attached to the distal end of the string. The string and tag are structured and arranged to facilitate inserting and removing the single-use, filter-paper material envelope from the inner volume of a drinking or a tea-brewing vessel.

### RELATED APPLICATION

This application claims the benefit of the US. Provisional Patent Application No. 62/317,405 filed on Apr. 1, 2016.

### FIELD OF THE INVENTION

The present invention relates generally to the field of sweetened beverages and more specifically to combined stevia leaves and tea in a single-use tea bag.

### DESCRIPTION OF THE RELATED ART

Tea is a beverage that is enjoyed by many, and it has health benefits, as well. Studies have found that some teas may help with cancer, heart disease, and diabetes prevention; encourage weight loss; lower cholesterol; and bring about mental alertness. Tea also may have antimicrobial qualities. Tea may be made from a wide variety of plant matter, however, purists consider only white tea, yellow tea, green tea, black tea, oolong tea, herbal tea, and pu-erh tea to be the authentic teas. These teas are all derived from the Camellia sinensis plant, a shrub native to China and India, and all contain unique antioxidants called flavonoids. The most potent of these, known as ECGC, may help against free radicals that can contribute to cancer, heart disease, and clogged arteries. Some of these teas also have caffeine and theanine, which can affect the brain and heighten a tea drinker's mental alertness.

Tea alone can have a bitter taste. In darker brews, the bitter taste may be pronounced. A sweetener is usually added to tea to reduce or eliminate the bitterness. Common sweeteners include natural sweeteners such as sugar, agave, and honey, or commercially-prepared artificial sweeteners. Natural sweeteners are typically high in caloric content, and use or overuse can counteract diabetes management, weight loss measures, and the cholesterol lowering efforts of a drinker. Use of commercially-prepared artificial sweeteners has been controversial due to the perception of increased cancer risks. In addition, commercially-prepared artificial sweeteners can have a chemical taste and are poor at providing the natural sweetener taste that drinkers desire. A suitable solution is desired.

Stevia rebaudiana is a plant species in the genus Stevia of the sunflower family (Asteraceae). Stevia is widely grown for its sweet leaves, which are the source of sweetener products known generically as stevia. The chemical compounds that produce its sweetness are various steviol glycosides, which have 250-300 times the sweetness of sugar. Sweet leaves of Stevia are raw material for sweetener products.

Stevia leaves have no calories. Using stevia leaves in place of sugar can help the user maintain and achieve a healthy weight. That is especially important for diabetic people, since more than 80 percent of people with type 2 diabetes are overweight.

Various attempts have been made to solve problems found in sweetened beverages. Some of these are disclosed in U.S. Patent and Publication Nos. 2009/0232941 to Farmer, 2014/0295049 to Ragot et. al., 2005/0152997 to Selzer, et. al., U.S. Pat. No. 5,322,700 to Drake, et. al., and CN Patent No. 1156543. These are only a representative of sweetened beverages.

None of the prior art taken either singly or in combination, is seen to describe the invention as claimed. Thus, a need exists for a reliable combined stevia and tea in a single-use tea bag, and to avoid the above-mentioned problems.

### SUMMARY OF THE INVENTION

The present invention advantageously fills the aforementioned deficiencies by sweetened beverages. The present invention is superior to other systems in that it effectively provides combined stevia and tea in a single-use tea bag.

The present invention is a tea bag comprising of a mixture of a plurality of tea leaves and a plurality of stevia leaves, wherein the plurality of stevia leaves comprise of one or two or three or four different sieve sizes of stevia leaves, and wherein the weight ratio of the tea leaves to the stevia leaves having a predefined ratio to add a controlled amount of a sweetening agent to a tea after steeping said tea bag for a steeping time.

Retrieving a sweetening agent from the stevia leaves and dissolution of the sweetening agent into the water depends to several factors. The temperature of the water, the size of the stevia leaves, and the steeping time are the main factors for retrieving and dissolving of the sweetening agent of the stevia leaves.

The stevia leaves in the present arrangement has different particle sizes from very fine size to fine size, medium size and coarse size. The fine particle size of the stevia leaves retrieve more sweetening agent into the water compared to the coarse particle sizes in a same condition (same water temperature, same steeping time).

The amount of tea leaves in a single-use tea bag is different based on the type of a tea leaves and user's preferences. The amount of tea leaves in a single-use tea bag typically ranges in between about 1 to 3 grams of tea leaves per tea bag.

A whole stevia leaf is about 30 times sweeter than sugar. Several sweet compounds of stevia have been isolated and named, including stevioside, steviobioside, dulcoside A and rebaudiosides A, B, C, D and E. These isolated substances vary in sweetness ranging from 50 to 450 times sweeter than sugar.

Health organizations have approved the stevia as a sweetener that is safe for people with diabetes if taken in amounts up to the Acceptable Daily Intake (ADI). The Acceptable Daily Intake (ADI) for stevia is 4 mg/kg body weight per day. For example, a 50 kg (110 lb) person can have 200 mg of Stevia per day.

The present invention combines different sieve sizes of stevia leaves with the tea leaves in a tea bag to retrieve a measurable unit of the sweetening agent in the water. Thereby, a user has a clear idea about the stevia consumption after one, two or more drinks in a day and can manage the daily intake carefully.

A preferred embodiment of the tea bag with stevia system is disclosed herein comprising a single-use, a paper envelope, tea leaves, stevia leaves, a string, and a tag. The paper envelope is structured and arranged to contain a proportional composition of tea leaves and stevia leaves in a ‘ready-to-brew’ condition with the string attached to the exterior of the filter-paper envelope and the tag attached to the distal end of the string. The string and tag are structured and arranged to facilitate inserting and removing the single-use, filter-paper envelope from a drinking or a tea-brewing vessel.

During an ‘in-use’ condition, a combined stevia and tea in a single-use tea bag may be prepared as a hot or a cold beverage for personal consumption. The single-use, filter-paper envelope with tea leaves and stevia leaves may be placed inside a drinking or tea-brewing vessel, such as a teapot, with the string suspending the tag on the exterior of the drinking or tea-brewing vessel. For a hot beverage, boiling water may be poured over the single-use, filter-paper envelope with tea leaves and stevia leaves. The user may allow the single-use, filter-paper envelope with tea leaves and stevia leaves to absorb the boiling water which releases the flavor and color of the tea leaves and dissolves the stevia leaves.

For a cold beverage preparation, cold water may be poured over the single-use, filter-paper envelope with tea leaves and stevia leaves. The user may allow the single-use, filter-paper envelope with tea leaves and stevia leaves to absorb the cold water to release the flavor and color of the tea leaves and to dissolve the stevia leaves. When the desired hot tea or cold tea strength is attained, the user may grasp the tag and extend the string in a manner to lift the single-use, filter-paper envelope to remove it from the inner volume of the drinking or tea-brewing vessel.

The bitter taste of the tea does not depend so much on the quantity of tea. Controlling the bitter taste of tea is normally done by controlling the steeping time. The steeping time of a tea is most determined by the coarseness of the tea leaves. For black tea, the common steeping time seems to be 2-3 minutes. There is little harm in steeping too short, but steeping too long will create a harsh bitter taste.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed.

This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The figures which accompany the written portion of this specification illustrate embodiments and method(s) of use for the present invention, a tea bag with stevia system, constructed and operative according to the teachings of the present invention.

FIG. 1 is a perspective view of a tea bag with stevia system during an ‘in-use’ condition showing a tea bag with stevia being brewed in a hot drink preparation according to an embodiment of the present invention;

FIG. 2 is a front perspective view illustrating the tea bag with stevia system comprising a tea bag with stevia assembly comprising tea leaves, stevia leaves, a string, and a tag according to an embodiment of the present invention; and

FIG. 3 shows different tea bags with variable brewing time and water temperature.

The various embodiments of the present invention will hereinafter be described in conjunction with the appended drawings, wherein like designations denote like elements.

### DETAILED DESCRIPTION OF PREFERRED EMBODIMENTS

The present invention is directed to a tea bag with stevia. In one embodiment of the present invention, a tea bag with stevia system may comprise a device to provide combined stevia and tea in a single-use tea bag.

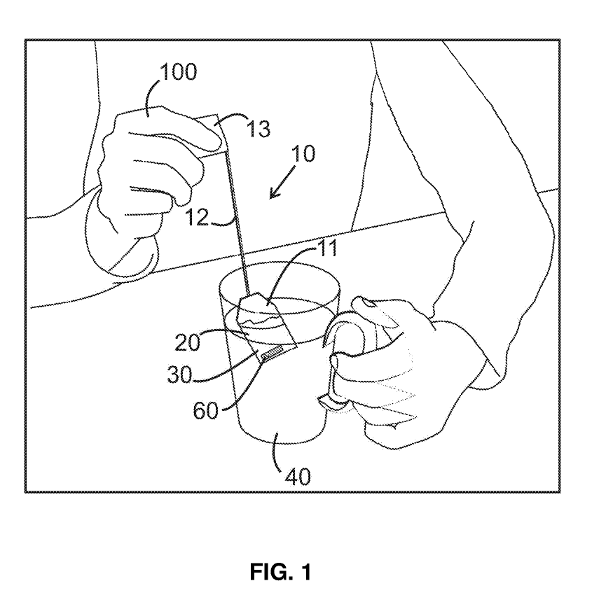

Referring now to the drawings, FIG. 1 shows a tea bag 10 with stevia leaves during an ‘in-use’ condition comprising a single-use, filter-paper envelope 11, tea leaves 20, stevia leaves 30, a string 12, and a tag 13. The filter-paper envelope 11 is structured and arranged to contain a proportional composition of tea leaves 20 and stevia leaves 30 in a ‘ready-to-brew’ condition, with the string 12 attached to the exterior of the filter-paper envelope 11 and the tag 13 attached to the distal end of the string 12. The string 12 and tag 13 are structured and arranged to facilitate inserting and removing the single-use, filter-paper envelope 11 from a drinking, or a tea-brewing, vessel 40. The tea leaves 20 may further comprise a plurality of combinations of tea varieties. Further, the tea leaves 20 may comprise a plurality of combinations of tea varieties, edible plant materials, and essential oils.

The stevia leaves 30 comprise of a plurality of stevia leaves such as stevioside, steviobioside, dulcoside A and rebaudiosides A, B, C, D and E. The stevia leaves 30 comprise of a plurality of combinations of stevia leaves such as stevioside, steviobioside, dulcoside A and rebaudiosides A, B, C, D and E.

The stevia leaves 30 comprise of a plurality of stevia leaves having different particle sizes such as a very fine particle size, a fine particle size, a medium particle size and a coarse particle size or combination of stevia leaves together. The solubility of stevia leaves in the water changes by the change in particle sizes. The size of stevia leaves affect the retrieving the sweetening agent and dissolving into the cold or hot water.

When a user makes a tea by the present invention arrangement, the temperature of the water, the size of the stevia leaves and the contribution of the particle size of the stevia leaves are predetermined. Therefore, by knowing the steeping time of the present arrangement, the amount of the sweetening agent dissolving into the water can be calculated.

In the present invention, a single-use, filter-paper envelope 11 further has a time measurement device 60 such as a color indicator 60 which changes its color by the time. For example, if the tea bag of the present invention arranges to retrieve 50 mg stevia into the water by having specific particle size of the stevia leaves in the tea bag in 45 seconds of steeping time; the user will notify by the color indicator (change in color) in the filter-paper envelop at 45 seconds steeping time to remove the tea bag from a drinking, or a tea-brewing, vessel 40.

For people with diabetes wherein the Acceptable Daily Intake (ADI) for stevia is predetermined; they can manage the consumption of tea and the amount of sugar or stevia per each cup of tea by the present invention arrangement.

In continuing to refer to FIG. 1, a combined stevia and tea in a single-use tea bag may be prepared as a hot or a cold beverage for personal consumption. For either a hot or a cold beverage preparation, the combined stevia and tea in a single-use tea bag may be placed within the inner volume of a drinking or tea-brewing vessel 40, while the string 12 is extended over the rim of the drinking or tea brewing vessel such that the tag 13 may be readily grasped by a user 100.

For a hot beverage preparation, boiling water may be poured over the single-use, filter-paper envelope 11 with tea leaves 20 and stevia leaves 30. The user 100 may allow the single-use, filter-paper envelope 11 with tea leaves 20 and stevia leaves 30 to absorb the boiling water to release the flavor and color of the tea leaves 20 and to dissolve the stevia leaves 30. When the desired sweetening agent is attained, the user 100 may grasp the tag 13 and extend the string 12 in a manner to lift the single-use, filter-paper envelope 11, thus removing it from the drinking or tea-brewing vessel 40.

In further referring to FIG. 1, for a cold beverage preparation, cold water may be poured over the single-use, filter-paper envelope 11 with tea leaves 20 and stevia leaves 30. The user 100 may allow the single-use, filter-paper envelope 11 with tea leaves 20 and stevia leaves 30 to absorb the cold water to release the flavor and color of the tea leaves and to dissolve the stevia leaves 30. When the desired sweetening agent is attained, the user may grasp the tag and extend the string in a manner to lift the single-use, filter-paper material envelope, thus removing it from the drinking or tea-brewing vessel.

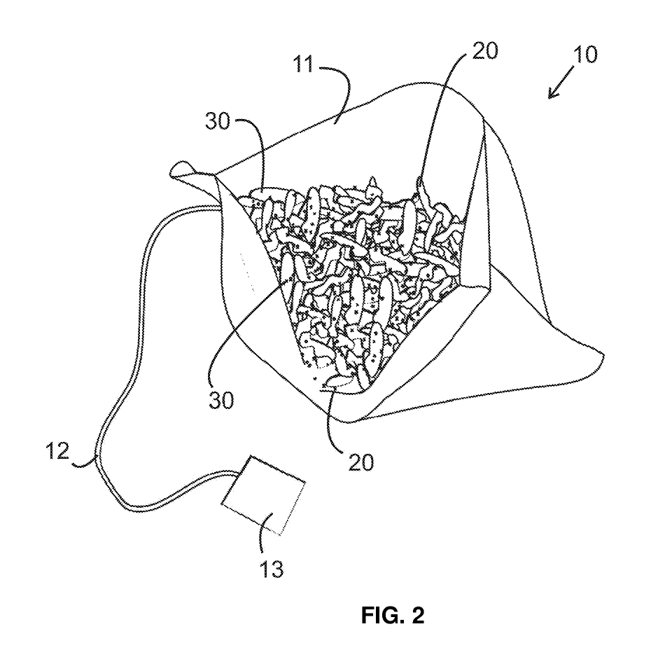

Referring now to FIG. 2 showing a front perspective view of a tea bag with stevia. A single-serving amount of a proportional composition of tea leaves 20 and stevia leaves 30 may be placed inside of the filter-paper envelope 11 to provide a preparation in a ‘ready-to-brew’ condition. The proportional composition of tea leaves 20 and stevia leaves 30 may comprise a combination that provides satisfactory flavorings to a user, thus eliminating the need for additional sweetening agents. The ‘ready-to-brew’ condition may comprise brewing methods that may comprise a hot beverage or a cold beverage. The string 12 may be attached to the exterior of the filter-paper envelope 11 and the tag 13 may be attached to the distal end of the string 12.

The following table defines the particle size of the stevia leaves in the present invention arrangement. The stevia leaves may comprise of variable sizes such as coarse particle size ranges more than 5 mm. medium particle size ranges from 1 to 5 mm, fine particle size ranges from 100 to 1000 μm and very fine particle size ranges between 25 to 100 μm.

| Stevia Leaves | Size range (metric) | |
|---|---|---|
| Coarse particle size | More than 5 mm | |
| Medium particle size | 1-5 | mm |
| Fine particle size | 100-1000 | μm |
| Very fine particle size | 25-100 | μm |

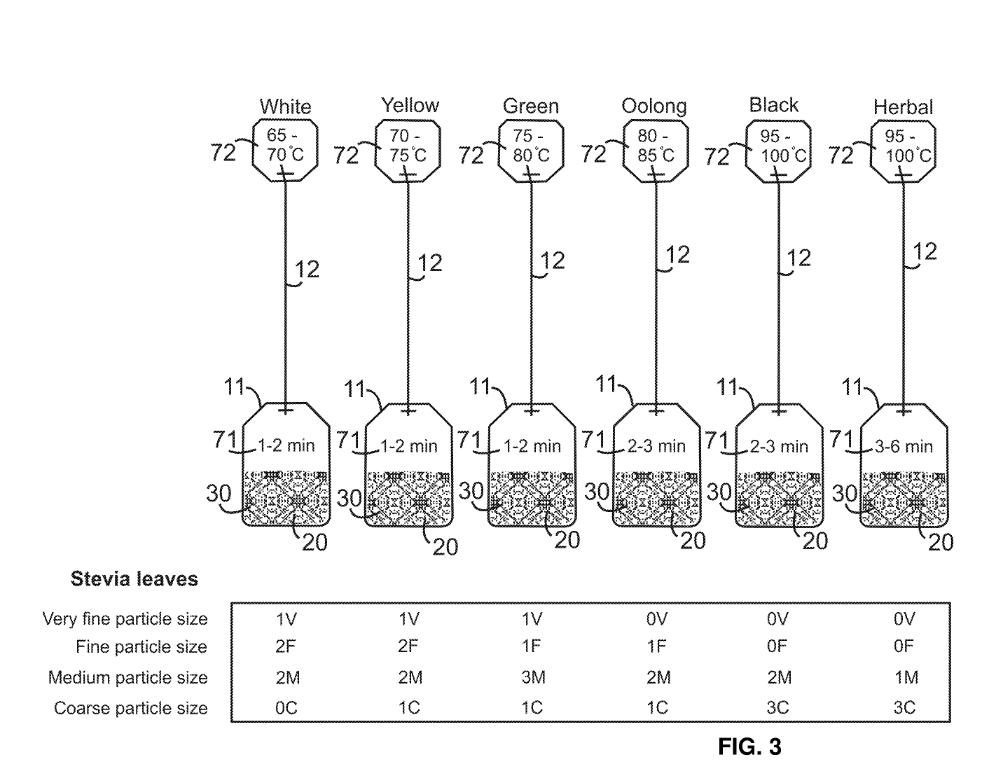

As shown in FIG. 3, the tea leaves are available in different varieties, and based on the type of the tea leaves inside the tea bag, the steeping time 71 and the water temperature 72 are different to achieve a desirable taste for the tea. The particle size of the stevia leaves 30 inside the tea bag 11 in the present invention arrangement designed in such a way that the amount of sweetening agent dissolve into the water in the steeping time 71 is measurable.

The stevia leaves 30 in the present invention comprises of variety of particle sizes which retrieve the sweetening agent into the water in different time from the steeping of the tea bag. The amount and the size of the stevia leaves inside the tea bag designed based on the type and the size of the tea leaves to retrieve a measurable amount of sweetening part into the water during the steeping time.

Again as shown in FIG. 3, the stevia leaves inside the tea bag 11 comprise of variable portion of different particle sizes such as coarse particle size, medium particle size, fine particle size and very fine particle size. Based on the type of the tea leaves inside the tea bag, the portion of particle size of the stevia leaves designed in such a way that in the brewing time of the tea, the measurable and desirable amount of the sweetening agent dissolves in the tea.

Again as shown in FIG. 3, the stevia leaves for a green tea with suggested brewing time of 1 to 2 mins and the water temperature of 75 to 80° C. comprises of 1 portion of very fine particle size, 1 portion of fine particle size, 3 portions of medium particle size and 1 portion of coarse particle size to retrieve X amount of sweetening agent into the water during the brewing process.

Again as shown in FIG. 3, the stevia leaves for a black tea with suggested brewing time of 2 to 3 mins and the water temperature of 95 to 100° C. comprises of no portion of very fine particle size, no portion of fine particle size, 2 portions of medium particle size and 3 portions of coarse particle size to retrieve X amount of sweetening agent into the water during the brewing process.

In a preferred embodiment of the present invention, the tea bag has a predefined ratio of the weight of the tea leaves to the weight of the stevia leaves. The predefined ratio of the weight of the tea leaves to the weight of the stevia leaves is about 1/(0.1) to 1/(0.01).

A tea bag may comprise of variable tea leaf grades such as whole leaf grades, broken leaf grades, fanning grades, and dust grades. The tea bag also may comprise of combination of variable tea leaf grades which represent variable brewing time and temperature. The present invention arrangement can manage a measurable sweetening agent into the water for variable tea leaf grades with different brewing time and temperature. Based on the variable size of the stevia leaves inside the tea bag; the measurable sweetening agent dissolve into the water during the brewing process by different water temperature and steeping time.

For example, it a user prefers to have a black tea with the present invention arrangement, the user steeps the tea bag into the hot water (95-100° C.) for 2-3 mins and remove the tea bag after 2-3 mins for brewing the tea. In such arrangement, the sweetening agent which dissolves into the hot water is pre-measured (e.g. 50 mg stevia) based on the amount and particle size of the stevia leaves inside the tea bag and the user has a clear idea of the amount of stevia consumption for the drink of the tea.

Additional embodiments of the present invention may include tea leaf and stevia leaf containment structures that may comprise paper, silk, Soilon (corn starch), polylactide (PLA) bioplastic, or other food-grade plastic compositions. The shape of the tea leaf and stevia leaf containment structure may further comprise rectangular, square, tetrahedron, or circular shapes. Further embodiments of the present invention may comprise a plurality of sizes of the tea leaf and stevia leaf containment structures which may comprise a plurality of serving sizes. The tea leaf and stevia leaf containment structures may be structured and arranged without the string and tag, thereby allowing a user to retrieve the tea leaf and stevia leaf containment structure from the drinking or tea-brewing vessel with a spoon or tongs. The tea leaf and stevia leaf containment structures may be individually wrapped for sanitary distribution or may be presented in a bulk container. Further, the attachment means for attaching the string to the tea leaf and stevia leaf containment structure may comprise food-grade adhesive or a food-grade staple. The attachment means for securing the tag to the string may also comprise food-grade adhesive or a food-grade staple. The exact specifications, materials used, and method of use of the tea bag with stevia system may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1) A tea bag comprising of a mixture of a plurality of tea leaves and a plurality of stevia leaves, wherein said plurality of stevia leaves comprise of one or two or three or four different sieve sizes of stevia leaves, wherein the weight ratio of said tea leaves to said stevia leaves having a predefined ratio to add a controlled amount of a sweetening agent to a tea after steeping said tea bag for a steeping time.

2) The tea bag of claim 1, wherein said sieve sizes of said stevia leaves are very fine, fine, medium, and coarse.

3) The tea bag of claim 2, wherein said coarse sieve size is more than 5 mm.

4) The tea bag of claim 2, wherein said medium sieve size ranges from 1 mm to 5 mm.

5) The tea bag of claim 2, wherein said fine sieve size ranges from 100 μm to 1000 μm.

6) The tea bag of claim 2, wherein said very fine sieve size ranges from 25 μm to 100 μm.

7) The tea bag of claim 1, wherein said tea is selected from the group consisting of a white tea, a yellow tea, a green tea, a black tea, an oolong tea, a herbal tea, and a pu-erh tea, and mixtures thereof, and a flavor.

8) The tea bag of claim 1, wherein said predefined ratio of the weight of the tea to the weight of the stevia leaves is about 1/(0.1) to 1/(0.01).

9) The tea bag of claim 1, further having a time indicator element to determine said steeping time for said tea bag.

10) The tea bag of claim 9, wherein said time indicator element is a color changing string attached to the tea bag that becomes dark after said steeping time.

11) A tea bag comprising of a mixture of a tea leaf and a stevia leaf.
